(19) United States
(12) Patent Application Publication
(10) Pub. No.: US 2024/0412966 A1
(43) Pub. Date: Dec. 12, 2024

(54) METHODS FOR DETECTING A SPECTRUM OF AN ION SPECIES, FOR SEGREGATING A MIXTURE OF A PLURALITY OF ION SPECIES, AND FOR DETERMINING A MIXTURE RATIO OF THE MIXTURE

(71) Applicant: UNIVERSITÄT ZU KÖLN, Köln (DE)

(72) Inventor: Stephan SCHLEMMER, Hürth (DE)

(21) Appl. No.: 18/703,581

(22) PCT Filed: Oct. 14, 2022
(86) PCT No.: PCT/EP2022/078664

§ 371 Date: Apr. 22, 2024

(30) Foreign Application Priority Data
Oct. 22, 2021 (DE) 10 2021 127 556.3

(51) Int. Cl. H01J 49/42

(52) U.S. Cl. CPC H01J 49/4225

(57) ABSTRACT

A method for detecting a spectrum of an ion species comprises the steps of a) capturing a subset of ions comprising the ion species in an ion trap; b) thermalizing the ions captured in the ion trap by a buffer gas; c) exciting the thermalized ions in the ion trap by electromagnetic radiation such that a kinetic energy of the ion species in the ion trap changes; and d) detecting the ions leaving the ion trap and/or detecting the ions remaining in the ion trap via a detector. In addition, the disclosure relates to a method for demixing a mixture of two or more ion species with equal mass-to-charge ratio and a method for determining a mixing ratio of a mixture of two or more ion species with equal mass-to-charge ratio. The disclosure further relates to a device for carrying out the above methods.

### INTRODUCTION

The disclosure relates to a method for detecting a spectrum of an ion species.

In addition, the disclosure relates to a method for demixing a mixture of two or more ion species with equal mass-to-charge ratio.

Furthermore, the disclosure relates to a method for determining a mixing ratio of a mixture of two or more ion species with equal mass-to-charge ratio.

Ion traps and in particular radio frequency (RF) ion traps have become important tools for ion spectroscopy. For example, so-called Paul traps were already used in the 1980s for high-resolution laser-induced fluorescence studies of N₂⁺ ions. In addition, an indirect spectroscopy method was introduced in which the reaction products of a vibrational dissociation of weakly bound ion complexes are observed. This method is now known as action spectroscopy, since the absorption of a photon by the ion complex is detected by the unimolecular decomposition of the complex, instead of detecting the loss of the incident photon as is usual in spectroscopic methods.

The technical article “Laboratory spectroscopy techniques to enable observations of interstellar ion chemistry” by McGuire, B. A., Asvany, O., Brünken, S., Schlemmer S., published in Nat Rev Phys 2, 402-410 (2020); DOI: 10.1038/s42254-020-0198-0 describes a method of action spectroscopy, called laser-induced reaction (LIR) method, in which mass-selected molecular ions (in the following abbreviated as AB) captured in an ion trap experience a mass change by excitation with electromagnetic radiation due to a chemical reaction and corresponding conversion into another chemical species. This mass change is detected by mass spectrometry as a change in the mass of the molecular ions stored in the ion trap.

The chemical reaction of the molecular ion AB can be, for example, a bimolecular process of the type AB+C==>A+BC, an attachment of a reaction partner to the molecular ion AB under investigation in the type of a termolecular process AB+C+M==>ABC+M (wherein M serves here as a catalyst), or a chemical decomposition reaction of the molecular ion AB in the type of AB==>A+B. A disadvantage of the LIR method is that only molecular ions can be investigated for which an endothermic chemical reaction exists, possibly with a reaction partner, and the reaction partner must also not condense under the cold conditions in the ion trap. This severely restricts the LIR method.

In addition, the above technical article further describes a method of action spectroscopy called laser-induced inhibition of complex growth (LIICG), in which a rate of complex formation of molecular ions AB captured in an ion trap with a reaction partner is changed by excitation with electromagnetic radiation. In other words, the equilibrium of the chemical reaction AB+2 C<==>ABC+C, in which the molecular ion AB experiences a mass change through chemical conversion into the other chemical species ABC, is influenced by excitation. The disadvantage of this is that in this case very cold temperatures of around 4 K are required—even lower temperatures for anions—and that the LIICG process is not background-free.

### SUMMARY

Based on this, it is an object per an embodiment of the disclosure to provide measures that simplify the detection of spectra of ions and in particular molecular ions. In particular, a method is to be provided in which spectra of ions can be detected without background and a chemical reaction partner, which converts the ion into another chemical species in a reaction process, can be dispensed with. In addition, a capability is to be provided to demix mixtures of ions and to determine the mixing ratio.

According to an embodiment, a method for detecting a spectrum of an ion species is provided, comprising the steps of
a) capturing a subset of ions comprising the ion species in an ion trap,
b) thermalizing the ions captured in the ion trap by a buffer gas,
c) exciting the thermalized ions in the ion trap by electromagnetic radiation such that a kinetic energy of the ion species in the ion trap changes, and
d) detecting the ions leaving the ion trap and/or detecting the ions remaining in the ion trap via a detector.

In an embodiment of action spectroscopy, reactions which lead to a chemical conversion of the ion species into another ion species and an associated change in mass are not caused as before, but the excitation of the ions captured in the ion trap comprising the ion species leads to a change, preferably an increase in the kinetic energy of the ion species captured in the ion trap. In other words, step c) comprises exciting the thermalized ions in the ion trap by electromagnetic radiation such that the kinetic energy of the ion species in the ion trap increases. The changed kinetic energy of the ion species, and the increased kinetic energy of the ion species, results in that the ion species overcomes a capture potential of the ion trap due to its kinetic energy and the ion species leaves the ion trap. Figuratively speaking, the ion species is accelerated by excitation with electromagnetic radiation. The capture potential of the ion trap is selected such that the swift ions of the ion species can leave the ion trap. Thus, by detecting the ions leaving the ion trap and/or detecting the ions remaining in the ion trap via the detector and, in particular, by counting the ions leaving the ion trap and/or the ions remaining in the ion trap via the detector, the spectrum of the ion species can be detected. In step d), the ions leaving the ion trap are detected via the detector, since a background-free spectrum of the ion species can be recorded in this way. This is because in this way a signal is only generated by the detector when the ions leave the ion trap and otherwise the signal is zero. Additionally or alternatively, a signal change is generated by the detector in step d) when a number of ions in the ion trap changes.

The method, per an embodiment, has the advantage that the spectrum of the ion species can be detected even with very small quantities of ions comprising the ion species captured in the ion trap. In other words, even a very small number of particles of the subset of ions comprising the ion species captured in the ion trap in step a) is sufficient. Thus, in an embodiment, the method is very sensitive. The sensitivity of the method compared to other spectroscopic methods is moreover increased in that the ions comprising the ion species are captured in the ion trap in step c)—i.e. during excitation—which prolongs the interaction time of the ions with the electromagnetic radiation. In addition, the method enables background-free spectra of the ion species to be detected. Compared to previously known methods of action spectroscopy, the method, per an embodiment, has the advantage that no chemical conversion of the ion species takes place, so that the method for determining the spectrum can be used more universally and is not merely restricted to ion species in which an endothermic reaction exists.

In principle, the ion species can comprise any ion species, i.e. also monatomic ions. Preferably, per an embodiment, the ion species is a molecular ion species, i.e. a charged polyatomic molecule. In addition, the ion species can be cations or anions. For anions in particular, the method, per an embodiment, has the advantage that no such low temperatures are required, as is the case in the prior art such as with the LIICG method. In principle, the method is suitable for detecting all types of spectra of the ion species, in particular for detecting rotational spectra, vibrational spectra, ro-vibrational spectra, electronic spectra and/or spectra of the spin transitions of the electrons or nuclei.

In a first step of the method per an embodiment, the subset of ions comprising the ion species is captured in the ion trap. In this way, the ion species is made available for subsequent spectroscopic examination. In principle, it is possible that the subset of ions captured in the ion trap is a mixture of different ions, wherein the mixture comprises the ion species to be examined. Alternatively, it is possible that the subset of ions consists exclusively of the ion species to be examined. Capturing the subset of ions, per an embodiment, is a capturing of the numerically closed subset—i.e. ions are not continuously added to the ion trap and removed at the same time in a dynamic equilibrium, but exactly the ions of the subset are captured in the ion trap in step a). It is also that, per an embodiment, the subset of ions is captured in a defined area of the ion trap by electromagnetic fields. This simplifies the excitation of the thermalized ions by electromagnetic radiation.

In a further step, the ions captured in the ion trap are thermalized. This means that a thermodynamic equilibrium is established between the ions captured in the ion trap and their environment, which is provided in particular by the buffer gas. In other words, after thermalization of the ions, a distribution of the energetic states of the ions can essentially be described by the Boltzmann statistics. Slight deviations from the Boltzmann statistics can occur due to the electromagnetic fields used to capture the ions in the ion trap. In addition, after thermalization of the ions, a velocity distribution of the ions captured in the ion trap can be described by the Maxwell-Boltzmann statistics. The buffer gas is, per an embodiment, a neutral, i.e. uncharged, buffer gas. Per an embodiment, the buffer gas is an inert buffer gas. Per an embodiment, the buffer gas is a noble gas, in particular helium.

Per an embodiment, step b) thermalization of the ions captured in the ion trap by the buffer gas comprises capturing the subset of ions comprising the ion species in the ion trap with the buffer gas for a predefined period of time, such that collisions occur between the ions comprising the ion species and the buffer gas. Any deviations in the distribution of the energetic states of the ions from the Boltzmann statistics and/or the velocity distribution from the Maxwell-Boltzmann statistics that may be present at the beginning of the process are reduced by collisions with the buffer gas in which ‘hot’ particles thermalize. Thus, per an embodiment, in step b), a pressure of the buffer gas is selected such that a collision frequency between the buffer gas and the ions captured in the ion trap after the predefined period of time leads to a reduction in a deviation of the distribution of the energetic states of the ions from the Boltzmann statistics and/or to a reduction in a deviation of the velocity distribution of the ions from the Boltzmann statistics. The thermalization of the ions captured in the ion trap by the buffer gas can, for example, take place via a thermalization pulse—i.e. a gas pulse of the buffer gas into the ion trap. It is further that, per an embodiment, the buffer gas is a cooling gas and the ion trap is a low-temperature ion trap. In this context, it may be provided that step b) comprises cooling the ions captured in the ion trap to a few Kelvin, preferably per an embodiment to 1 K to 120 K, particularly preferably per an embodiment to 4 K to 100 K via the buffer gas. In other words, the buffer gas absorbs the thermal energy of the ions and thus also ensures that the ions in the ion trap are present in a more ordered state and thus a lower number of quantum mechanical states are occupied.

In the next step of the process, the thermalized ions in the ion trap are excited by electromagnetic radiation. The interaction with the electromagnetic radiation causes the ions excited by the electromagnetic radiation and, in particular, the ion species excited by the electromagnetic radiation, to be transferred to an energetically higher state. Subsequent collisions of the excited ion species with the buffer gas or further buffer gas convert at least part of the energy stored in the excited state into kinetic energy, also known as translational energy or kinetic energy. In this way, as already mentioned, the excitation of the ions captured in the ion trap comprising the ion species leads to a change, and in particular to an increase in the kinetic energy of the ion species—without chemically converting the ion species into another ion species.

Due to the changed kinetic energy of the ion species, the ion species overcomes the capture potential of the ion trap. Thus, in particular, the term “leaving the ion trap” here means that the ion species overcomes the capture potential of the ion trap. Accordingly, in the step following the excitation, a signal is generated by detecting the ions leaving the ion trap via the detector precisely when the electromagnetic radiation used for excitation in step c) corresponds in its frequency to an energetic transition of the ion species. Alternatively or additionally, in the step following the excitation, a signal change is generated by detecting the ions remaining in the ion trap via the detector precisely when the electromagnetic radiation used for excitation in step c) corresponds in its frequency to an energetic transition of the ion species. Thus, the method can be used to detect the spectrum of the ion species.

In other words, the method according to an embodiment for detecting the spectrum of an ion species is a combination of absorption spectroscopy, in which the ion species absorbs the electromagnetic radiation and is indirectly converted into a state of higher kinetic energy, with detection by mass spectrometry. In this method, the ion species, per an embodiment mass-selected, to be examined is therefore addressed spectroscopically.

With regard to mass spectrometry and in particular with regard to step d) and/or with regard to counting the ions leaving the ion trap and/or with regard to counting the ions remaining in the ion trap by means of the detector, it is provided that the detection of the ions leaving the ion trap via the detector and/or the detection of the ions remaining in the ion trap via the detector comprises detecting the ions via a single-ion detector, for example a secondary electron multiplier.

Furthermore, it is provided per an embodiment in this context that the detection of the ions leaving the ion trap via the detector and/or the detection of the ions remaining in the ion trap via the detector comprises collecting the ions leaving the ion trap and/or collecting the ions remaining in the ion trap in a second ion trap and/or in a further region of the ion trap. In other words, the ions can be transferred to a second ion trap or transferred to a second region of the ion trap for detection. In an embodiment, the second region of the ion trap is to be understood as a region of the ion trap which, due to the field distribution of the electromagnetic fields in the ion trap, fulfills the same function as an independent ion trap and in this way the ions can be captured in this second region. In other words, the ions leaving the ion trap can also first be collected in a further ion trap or the second region of the original ion trap and then supplied in common to the detector for counting.

According to an embodiment, it is provided that in step c) the mass of the ion species does not change and/or no chemical reaction of the ion species with the buffer gas and/or a reaction partner takes place. In contrast to the prior art, excitation with electromagnetic radiation does not trigger a chemical reaction of the ion species and the associated change in mass. In particular, the mass of the ion species remains the same throughout the entire process. Further, moreover, a charge of the ion species does not change in step c).

Also in connection with step c), according to an embodiment, it is provided that in step c) an energetic transition of the ion species is excited by the electromagnetic radiation. In an embodiment, a frequency of the electromagnetic radiation used for excitation coincides with a frequency of the energetic transition of the ion species. In other words, the ion species is excited resonantly in step c). The energetic transition of the ion species can in principle be any energetic transition, particularly a rotational transition, vibrational transition, electronic transition and/or spin transition. The frequency of the electromagnetic radiation is adapted to the frequency of the electrical transition and is in the UV to visible range of the electromagnetic spectrum for electronic transitions of the valence electrons, in the IR range for vibrational transitions, in the microwave range for rotational transitions, in the microwave range for spin transitions of the electrons and in the microwave to radio wave range for spin transitions of the atomic nuclei.

Furthermore, according to an embodiment, it is provided that step c) comprises converting internal energy of the ion species into kinetic energy of the ion species. Here, internal energy of the ion species does not mean the thermodynamic quantity internal energy U of the system, in the consideration of which contributions of the kinetic energy are also taken into account, but an energy of the ion species which is stored in internal degrees of freedom of the ion species. The internal degrees of freedom are internal degrees of freedom of the ion species such as rotation, vibration, electronic states and nuclear spin states. These states are linked to each other in many ways via the laws of quantum mechanics, so that the addressing of one degree of freedom can be automatically linked to the addressing of other degrees of freedom and thus information about several states can be obtained simultaneously. This behavior is particularly pronounced when linking the nuclear spin states with the states of the spatial internal motion of the ion species. In particular, it is envisaged that the conversion of internal energy of the ion species into kinetic energy of the ion species takes place by collisions of the ion species with the buffer gas or a further buffer gas. Thus, step c) comprises exciting the thermalized ions in the ion trap by the electromagnetic radiation in the presence of the buffer gas or a further buffer gas.

In this connection, according to an embodiment, it is provided that step c) comprises increasing the internal energy of the ion species by excitation by means of electromagnetic radiation and converting the increased internal energy of the ion species into kinetic energy of the ion species by collisions of the ion species with the buffer gas and/or a further buffer gas. In an embodiment, a pressure of the buffer gas or the further buffer gas in the ion trap is thus selected such that the increased internal energy of the ions is converted into kinetic energy of the ion species by collisions of the ion species with the buffer gas. In particular, the pressure of the buffer gas or the further buffer gas is selected such that thermalization does not occur as in step b). In other words, the pressure of the buffer gas or the further buffer gas is selected such that the statistically expected number of collisions of the ion species with the buffer gas or the further buffer gas is not so high that thermalization occurs due to secondary collisions in which the buffer gas or the further buffer gas absorbs the increased internal energy of the ion species. On the other hand, the statistically expected number of collisions is also high enough that a collision-induced conversion of the increased internal energy into kinetic energy takes place in the ion species. In an embodiment, the pressure of the buffer gas or the further buffer gas in step c) is constant. This is in contrast to step b), in which a thermalization pulse is used.

In this context, it is provided per an embodiment that an impact-induced increase in the kinetic energy of the ion species takes place within a period of ≤1 ms after the excitation of the thermalized ions in the ion trap by electromagnetic radiation. This time is selected so short that a spontaneous de-excitation of the internal excitation—i.e. the increased internal energy—of the ions is unlikely and instead the impact-induced increase in kinetic energy becomes likely. In contrast, a thermalization, in which the buffer gas or the further buffer gas absorbs the increased internal energy of the ion species—which actually is avoided in the present case—would take place within a period of 2 ms after excitation of the thermalized ions in the ion trap by electromagnetic radiation.

In this context, according to an embodiment, it is provided that in step b) the ions captured in the ion trap are thermalized, and in step c) are excited by electromagnetic radiation in such a way that after excitation by electromagnetic radiation the internal energy of the ion species is higher than the kinetic energy of the ion species after thermalization. In other words, the ions comprising the ion species have such a low kinetic energy after thermalization in step b) that directly after excitation of the thermalized ion species by electromagnetic radiation in step c), the internal energy of the ion species increased by excitation is greater than the kinetic energy of the ion species. This simplifies that at least a part of the internal energy of the ion species is subsequently converted into kinetic energy due to collisions of the ion species with the buffer gas or the further buffer gas, so that the kinetic energy of the ion species increases. In particular, the kinetic energy of the ion species increases to such an extent that the increased kinetic energy of the ion species exceeds the storage potential of the ion trap and thus the ion species leaves the ion trap.

According to an embodiment, it is provided that in step a) a subset of mass-selected ions comprising the ion species is captured in the ion trap. In the present case, mass-selected ions are to be understood as ions which have equal mass-to-charge ratio m/z. Thus, for ions with the same charge, this means that the ions also have the same mass. This simplifies the detection of the spectrum of the ion species and the detection of the ions remaining in the ion trap by means of the detector. If the subset is present as a mixture of different ions, it is therefore a mixture of isobaric ions, i.e. ions that have equal mass-to-charge ratio m/z in a given precision but different compositions, linkages and/or arrangements of the atoms. Examples of a mixture of isobaric ions are the molecular ions CO⁺, N₂⁺ and C₂H₄⁺ with a nominal mass-to-charge ratio m/z of 28, or as a further example isomers—i.e. chemical compounds with the same molecular formula and correspondingly the same molecular mass, but which differ in the linkage and/or the spatial arrangement of the atoms to one another.

According to an embodiment, it is provided that in step a) for capturing the subset of ions a storage potential of the ion trap is selected such that the ion species with changed kinetic energy leaves the ion trap. In other words, the ion species with increased kinetic energy leaves the ion trap after step c) has been carried out. The storage potential of the ion trap is selected per an embodiment such that the increase in kinetic energy caused by the excitation of the ion species is sufficient for the ion species to leave the ion trap after step c) has been carried out. In an embodiment, the storage potential in step a) is matched to the ion species and the spectrum—i.e. the energetic transition of the ion species to be excited in the following step.

In this context, it is provided that the ion trap is a radio frequency ion trap and/or a high frequency ion trap and per an embodiment a radio frequency multipole ion trap or a so-called Penning ion trap. For example, the ion trap is a Paul trap, in which the ions are captured in the ion trap by means of an alternating electric field. In an embodiment, step a) comprises capturing the subset of ions comprising the ion species in the radio frequency ion trap and/or the high frequency ion trap and in the radio frequency multipole ion trap. Radio frequency ion traps allow the storage potential to be set particularly precisely via the electric field.

With regard to the detection of the ions leaving the ion trap and/or the detection of the ions remaining in the ion trap, according to an embodiment it is provided that in step d) a mass setting of the detector corresponds to the mass of the ion species. Unlike the action spectroscopy methods described in the prior art, in which a chemical conversion of the ion species to be examined spectroscopically into a chemically different ion species takes place, resulting in a change in mass and correspondingly also the mass setting of the detector for detecting the spectrum of the ion species does not correspond to the mass of the ion species, but to the mass of a reaction product, in an embodiment no chemical conversion of the ion species takes place during the method. Accordingly, for detecting the ions leaving the ion trap and/or the ions remaining in the ion trap, the mass setting of the detector, which corresponds to the mass of the ion species to be examined spectroscopically, is to be used.

According to an embodiment, it is provided that the method comprises the steps of
e) removing all ions from the ion trap, and
f) repeating steps a) to e) with further subsets of the ions,
wherein during the repetition in step c) the electromagnetic radiation has each time a different frequency than before.

Thus, per an embodiment, after the first subset of ions comprising the ion species has been resonantly excited in the ion trap, and subsequently the excited ion species has left the ion trap and this has been detected by means of the detector, all remaining ions are removed from the ion trap in order to start the process from the beginning with capturing of a further subset of ions comprising the ion species in the ion trap. This makes it possible to excite the thermalized ions of the further subset of ions in the ion trap with a different frequency of electromagnetic radiation than before and thus to process all frequency measuring points of the spectrum of the ion species with a respective new subset of ions by repeatedly executing the method several times. If a frequency is used for excitation in step c) that does not correspond to an energetic transition of the ion species, i.e. is not resonant, the kinetic energy of the ion species is not changed so that the ion species cannot leave the ion trap. Accordingly, the detector does not generate a signal and/or no signal change in this case.

In connection with the repeated execution, according to an embodiment, it is provided that step d) comprises detecting the ions leaving the ion trap and/or detecting the ions remaining in the ion trap via the detector as a function of the excitation frequency. Thus, a spectrum of the ion species with x- and y-axis is provided, in which the detector signal, which is generated by the detector when detecting the ions leaving the ion trap and/or when detecting the ions remaining in the ion trap (y-axis), is plotted against the excitation frequency (x-axis). In an embodiment, the ions leaving the ion trap are detected as a function of the excitation frequency by means of the detector. In this context, it is provided that the ions leaving the ion trap are collected in a further ion trap and/or are collected in a second region of the ion trap and then detected. This increases the sensitivity of the method.

The disclosure, per an embodiment, not only enables to detect the spectrum of the ion species, but also to demix a mixture of isobaric ions and determine the mixing ratio. In this context, the disclosure, per an embodiment, provides a method for demixing a mixture of two or more ion species with equal same mass-to-charge ratio, comprising the steps of
a) capturing the ions comprising the mixture of two or more ion species with equal mass-to-charge ratio in an ion trap,
b) thermalizing the ions captured in the ion trap by a buffer gas, and
c) exciting exactly one ion species of the mixture of the thermalized ions in the ion trap by electromagnetic radiation such that a kinetic energy of this ion species in the ion trap changes,
wherein in step a), in order to capture the ions comprising the mixture, a storage potential of the ion trap is selected such that all particles of the ion species excited in step c) leave the ion trap after executing step c).

In addition, in an embodiment a method for determining a mixing ratio of a mixture of two or more ion species with equal mass-to-charge ratio is provided, comprising the steps of
a) capturing the ions comprising the mixture of two or more ion species with equal mass-to-charge ratio in an ion trap,
b) thermalizing the ions captured in the ion trap by a buffer gas,
c) exciting exactly one ion species of the mixture of thermalized ions in the ion trap by electromagnetic radiation such that a kinetic energy of this ion species in the ion trap changes, and
d) detecting the ions leaving the ion trap and/or detecting the ions remaining in the ion trap by means of a detector,
wherein in step a), in order to capture the ions comprising the mixture, a storage potential of the ion trap is selected such that particles of the ion species excited in step c) leave the ion trap after step c) has been executed.

The steps of these two methods are analogous to the method for detecting a spectrum of an ion species, with the difference that in the first step not a subset of ions comprising the ion species is captured in the ion trap, but the mixture of two or more ion species with equal mass-to-charge ratio. In other words, a mixture of isobaric ions is provided in step a). In addition, in the method for demixing the mixture of two or more ion species with equal mass-to-charge ratio, steps a) and c) are executed in such a way that all particles of the ion species excited by the electromagnetic radiation leave the ion trap. In other words, in step c), all particles of exactly one ion species of the mixture of thermalized ions in the ion trap are excited by electromagnetic radiation in such a way that they leave the ion trap.

In the method for determining the mixing ratio of the mixture of two or more ion species, however, it is not necessary that steps a) and c) are carried out in such a way that all particles leave the ion trap. In order to determine the mixing ratio, the total number of the particles of the ion species that were excited in step c) can also be inferred from a time course of a detector signal detected in step d)—even at a time before all particles of this ion species have left the ion trap. The detector signal per an embodiment has an exponential curve. Accordingly, the mixing ratio of the mixture can also be determined if not all of the particles excited in step c) have left the ion trap, but only a proportion of the excited particles. In an embodiment, however, steps a) and c) are also carried out in the method for determining the mixing ratio in such a way that all particles of the ion species excited by the electromagnetic radiation leave the ion trap.

The method for demixing the mixture of two or more ion species with equal mass-to-charge ratio and the method for determining the mixing ratio of the mixture of two or more ion species with equal mass-to-charge ratio preferably comprise, following step c), waiting for a predefined period of time until all particles of the ion species excited in step c) leave the ion trap. In addition, the detector signal generated by the detector in step d) when detecting the ions leaving the ion trap and/or when detecting the ions remaining in the ion trap, and in particular by a change in the detector signal over time, can be used to determine when all particles of the ion species excited in step c) have left the ion trap. Further per an embodiment, in step a) a finite number of ions comprising the mixture of two or more ion species with equal mass-to-charge ratio is captured in the ion trap and in step c) it is waited long enough until all particles of the ion species excited in step c) have left the ion trap.

Both methods, per an embodiment, are based on the fact that resonant excitation of exactly one ion species of the mixture causes this ion species to leave the ion trap, which results in selective demixing of the mixture. By detecting the ions leaving the ion trap and/or by detecting the ions remaining in the ion trap by use of the detector, moreover, the mixing ratio can be determined. In particular, in step c) electromagnetic radiation is used for excitation, the frequency of which corresponds to a frequency of an energetic transition of exactly one ion species of the mixture. In other words, the method for demixing the mixture of two or more ion species equal mass-to-charge ratio and the method for determining the mixing ratio of the mixture of two or more ion species with equal mass-to-charge ratio thus utilize the possibility that the ion species of an isobaric mixture are spectroscopically distinguishable and can be selectively excited accordingly for demixing and for determining the mixing ratio of the isobaric mixture.

According to an embodiment, the method comprises the step e) determining whether a transition frequency belongs to a different ion species of the mixture than the ion species excited in step c) by irradiating electromagnetic radiation having a different frequency than was used for excitation in step c).

In other words, it is thus determined per an embodiment in a further step whether a frequency which is different from the frequency used in step c) corresponds to an energetic transition of an ion species of the mixture different from that excited in step c): If all particles of one ion species of the mixture leave the ion trap by addressing this one ion species in step c) by excitation at one frequency of the electromagnetic radiation, then it can be determined by irradiating electromagnetic radiation at a different frequency whether this different frequency excites an energetic transition belonging to a different ion species of the mixture. If the other frequency would correspond to an energetic transition of the ion species that was already excited in step c) and has left the ion trap accordingly, the number of ions in the ion trap would not decrease further when the electromagnetic radiation with the other frequency is irradiated. If, on the other hand, the other frequency corresponds to an energetic transition of another ion species of the mixture, the number of ions in the ion trap will decrease after irradiation with electromagnetic radiation at the other frequency. In this way, the spectra of the respective ion species of the mixture can be determined. Alternatively, a remaining proportion of the ions in the ion trap can be determined for each frequency which also enables to assign the spectra.

The method for demixing the mixture of two or more ion species with equal mass-to-charge ratio and the method for determining the mixing ratio of the mixture of two or more ion species with equal mass-to-charge ratio enable to separate ion species with equal mass-to-charge ratio from one another, which has not been possible to date by use of mass spectrometric methods. In particular, not only chemical compounds with different molecular formulas but nominally equal mass-to-charge ratio, such as CO⁺, N₂⁺and C₂H₄⁺, can be separated from each other, but also isomers, i.e. chemical compounds with the same molecular formula which, however, differ in the linkage and/or the spatial arrangement of the atoms to each other. In other words, the methods enable the demixing and determination of mixing ratios for mixtures of constitutional isomers, stereoisomers, configurational isomers, conformational isomers (also called conformers), diastereomers and enantiomers. For example, a mixture of HCO⁺ and HOC⁺ can be demixed and the mixing ratio can be determined by use of the methods. The methods can also be used to separate nuclear spin isomers from one another, i.e. chemical compounds that differ from each other only in the state of the spins of the atomic nuclei. This is due to the link between the spectroscopically addressable states and the nuclear spin states via the laws of quantum mechanics.

In particular, the method for demixing a mixture of two or more ion species with equal mass-to-charge ratio can also be used to generate samples for spectroscopic investigations that have only one spectroscopic species. In other words, the ion species is selected from the group comprising isomers, constitutional isomers, stereoisomers, configurational isomers, conformational isomers, diastereomers, enantiomers and spin isomers.

With regard to demixing of enantiomers and determining the mixing ratio of enantiomers, it is provided per an embodiment that the mixture of two or more ion species with equal mass-to-charge ratio is a mixture comprising two enantiomers, namely a chiral (S) ion species and an (R) ion species enantiomeric to the (S) ion species, and that step c) comprises exciting exactly one enantiomer of the mixture of the thermalized ions in the ion trap by electromagnetic radiation and with an enantiomer-specific excitation scheme such that a kinetic energy of this enantiomer changes. The enantiomer-specific excitation scheme is per an embodiment a method of enantiomer-specific microwave spectroscopy (EMS). Further, the enantiomer-specific excitation scheme is a microwave-induced coherent population transfer in which dipole-allowed rotational transitions are excited by phase-controlled microwave pulses, wherein selectively either the R-form or the S-form of the ion species is transferred to a higher rotational state. A dipole-allowed rotational transition is understood here to be a transition between two rotational states of the ion species which has a non-zero transition dipole moment.

The disclosure also relates to a device for carrying out one of the methods described above. The device comprises an ion trap, wherein the ion trap comprises a plurality of electrodes for generating a radio frequency field, wherein the electrodes are arranged in a multipole electrode configuration, and wherein the device comprises a ring electrode arranged around the ion trap.

An aspect of the device, per an embodiment, is that the ring electrode is arranged around the ion trap. The ion trap comprises a plurality of electrodes for generating the radio frequency field used to capture the ions in the ion trap. The electrodes are arranged in a multipole electrode configuration, for example in a quadrupole configuration or in a 22-pole configuration. In an embodiment, the ion trap is an ion trap whose electrodes are arranged in a 22-pole electrode configuration. To enable a particularly precise adjustment of the ion trap potential, the device comprises the ring electrode. The ring electrode is arranged around the ion trap and particularly preferably around the electrodes arranged in a multipole electrode configuration. Applying a voltage to the ring electrode results in very little change in the potential of the ion trap due to the electrical penetration factor. For example, applying a voltage of 1 V to the ring electrode changes the potential of a 22-pole ion trap by 0.6 meV, which corresponds to an electrical potential of 0.6 mV. The voltage of the ring electrode is thus reduced by a factor of approximately 1600.

The ring electrode thus enables in a particularly easy way to select a storage potential of the ion trap in step a) of the process for capturing the subset of ions in such a way that the ion species with changed kinetic energy leaves the ion trap. In other words, the ring electrode can be used to create a very low potential barrier in the ion trap. This means that via the ring electrode a discrimination of the swift ions—i.e. the ion species with increased kinetic energy—can be very finely adjusted from the thermalized ions up to very low energy values.

Furthermore, it is possible per an embodiment that the device comprises not just one, but several ring electrodes. The ring electrode, per an embodiment, is arranged around the ion trap in such a way that a central axis of the ring electrode extends parallel to a longitudinal axis of the ion trap. Further per an embodiment, the height of the potential barrier can be adjusted by changing the size of the ring electrode or a distance between the electrodes and the ring electrode.

According to an embodiment, it is provided that the device comprises a further ion trap, wherein the first ion trap and the further ion trap are connected to each other in such a way that ions leaving the first ion trap are collected in the further ion trap. This increases the sensitivity of the detection of the ions leaving the ion trap. The further ion trap can also be a second region in the first ion trap, wherein the electromagnetic fields of the first ion trap are designed in such a way that ions can also be captured in the second region and accordingly the second region fulfills the same function as an independent second ion trap. The second ion trap and/or the second region enable the ions leaving the ion trap to be collected in the further ion trap or the second region of the original ion trap and then to be supplied together to a detector for counting.

It is in this context that, per an embodiment, the device comprises a detector, a single-ion detector, for example a secondary electron multiplier. Further, the detector is designed in such a way that the ions leaving the ion trap are counted via the detector and/or that the ions remaining in the ion trap are counted via the detector.

Further features and advantages of the device are apparent to the person skilled in the art from the description of the methods.

### BRIEF DESCRIPTION OF THE FIGURES

In the following, the invention is explained by way of example with reference to the drawing based on preferred exemplary embodiments.

In the drawings:

FIG. 1 shows a schematic representation of a spectrum of an ion species recorded according to a method for detecting a spectrum of an ion species according to an embodiment;

FIG. 2 shows a schematic representation of a signal of a detector recorded when carrying out a preliminary test for a method for demixing a mixture and/or for determining a mixing ratio of two or more ion species, according to an embodiment;

FIG. 3 shows a schematic representation of a further spectrum of an ion species recorded according to a method for detecting a spectrum of an ion species, according to a further embodiment; and

FIG. 4 shows a schematic representation of an effective potential of an ion trap of a device which can be used for carrying out a method for detecting a spectrum of an ion species, according to an embodiment.

### DETAILED DESCRIPTION

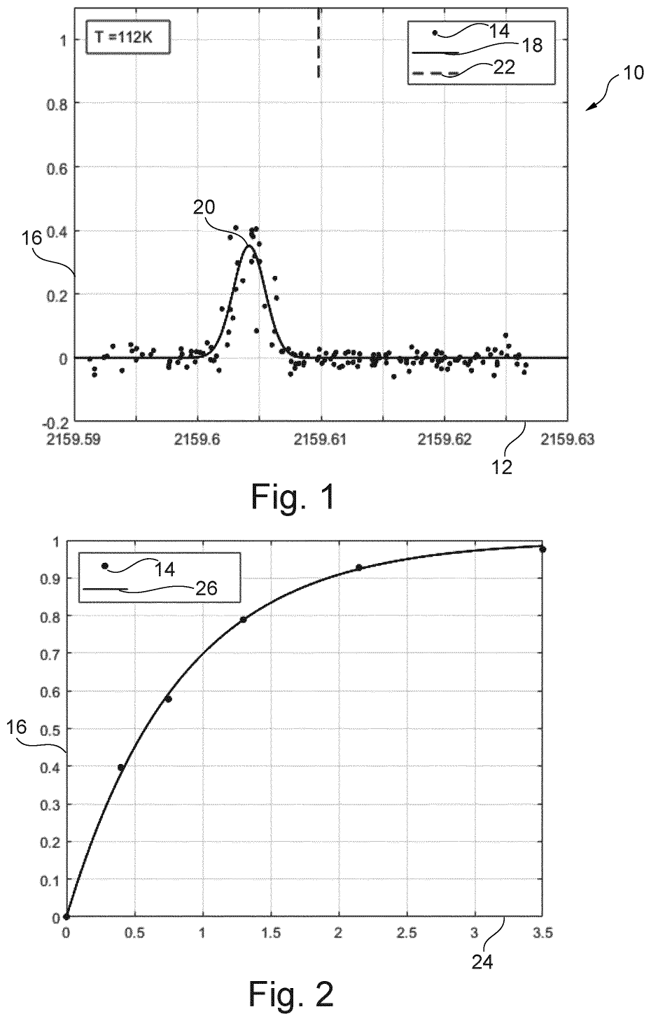

FIG. 1 shows a schematic representation of a spectrum 10 of the ion species HCO⁺ recorded according to a method for detecting a spectrum 10 according to an embodiment. For this purpose, in the present exemplary embodiment, a subset of the ion species HCO⁺ was captured in a 22 pole ion trap. In addition, the HCO⁺ ions in the ion trap were thermalized to 112 K by use of a buffer gas. The thermalized HCO⁺ ions were then excited in the ion trap by electromagnetic radiation. The electromagnetic radiation used for excitation has a wave number between 2159.59 cm⁻¹ and 2159.63 cm⁻¹, which also corresponds to the x-axis 12 of spectrum 10. In the range between approximately 2159.600 cm⁻¹ and 2159.607 cm⁻¹, the electromagnetic radiation has a frequency that corresponds to the Ro vibrational transition of the HCO⁺ ions, in which the CO stretching vibration is excited. Excitation of the thermalized HCO⁺ ions disposed in the ion trap by electromagnetic radiation of these frequencies leads to an increase in the kinetic energy of the HCO⁺ ions in the ion trap in such a way that the HCO⁺ ions can leave the ion trap. In a step following the excitation with a specific frequency, the leaving of the HCO⁺ ions is indirectly detected by a detector that counts the ions remaining in the ion trap. The detector signal of the detector after excitation with a specific excitation frequency respectively corresponds in principle to a measuring point 14 of the spectrum 10 shown in FIG. 1. However, the normalized detector signal is plotted on the y-axis 16 of the spectrum 10 in FIG. 1.

Following the excitation of the ions at a specific frequency and the recording of the detector signal, all ions are removed from the ion trap and a new subset of HCO⁺ ions is captured in the ion trap. Like the first subset, these HCO⁺ ions are thermalized by use of a buffer gas and then excited by electromagnetic radiation. The electromagnetic radiation used for excitation has a different frequency than before, so that the next measuring point 14 of the spectrum 10 is recorded by use of the detector. The process is repeated until all frequency measuring points on the x-axis 12 have been processed.

In a frequency range of the electromagnetic radiation that no longer corresponds to the frequency of an energetic transition of the HCO⁺ ions (i.e. in the present case from about 2159.59 cm⁻¹ to 2159.600 cm⁻¹ and from about 2159.607 cm⁻¹ to 2159.63 cm⁻¹), the kinetic energy of the HCO⁺ ions is not increased so that they do not leave the ion trap. Accordingly, the detector signal remains constant in these ranges.

FIG. 1 also shows a Gaussian curve 18 whose parameters were adjusted to the measuring points 14 by means of curve fitting. The deviation of the frequency of the maximum value 20 of the Gaussian curve 18 from the value 22 of the frequency for the CO stretching vibration in HCO⁺ ions of 2159.61 cm⁻¹ known in the literature is due to an incomplete frequency calibration.

FIG. 2 shows the detector signal in a preliminary test of a method for demixing a mixture and/or for determining a mixing ratio of two or more ion species with equal mass-to-charge ratio, according to an embodiment.

In the method for demixing a mixture and/or for determining a mixing ratio of two or more ion species with equal mass-to-charge ratio, the mixture is captured in a first step in an ion trap, analogous to the method for detecting the spectrum, and thermalized by a neutral buffer gas. Subsequently, exactly one ion species of the mixture of thermalized ions in the ion trap is excited by electromagnetic radiation in such a way that a kinetic energy of the excited ion species in the ion trap changes. In addition, in order to capture the mixture of ions, a storage potential of the ion trap is selected in such a way that the particles with changed kinetic energy leave the ion trap.

FIG. 2 now shows the detector signal in a preliminary test to determine a time period for the ion species HCO⁺ after which all HCO⁺ ions captured in the ion trap have left the ion trap after excitation of the CO stretching vibration by electromagnetic radiation. The time in seconds is plotted on the x-axis 24 in FIG. 2, and the normalized detector signal recorded by the detector is plotted on the y-axis 16, analogous to FIG. 1.

FIG. 2 also shows an exponential function curve 26 of the form 1−e^{(-ax)}, the parameters of which were adjusted to the measuring points 12 by means of curve fitting. FIG. 2 shows that saturation occurs with increasing time due to the limited number of HCO⁺ ions captured in the ion trap. After approximately 3.5 seconds, all the HCO⁺ ions previously excited in the ion trap have left the ion trap.

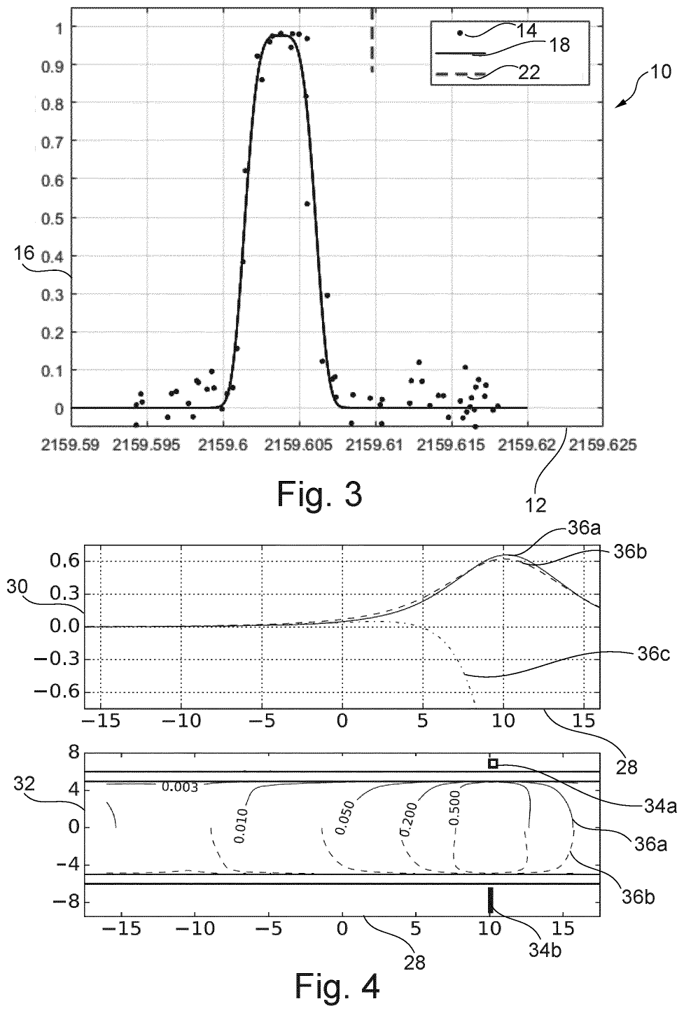

FIG. 3 shows, analogous to FIG. 1, a schematic representation of a spectrum 10 of the ion species HCO⁺, which was recorded analogously to the previously described method for detecting a spectrum 10, according to an embodiment. In contrast to FIG. 1, in which the Gaussian curve 18 adapted to the measurement points 14 by curve fitting has a typical bell shape, the Gaussian curve 18 adapted to the measurement points 14 by curve fitting in FIG. 3 is distorted. This is due to the fact that for the spectrum in FIG. 3, the 3.5 seconds determined in FIG. 2 were waited for each frequency measurement point after the HCO⁺ ions captured in the ion trap were excited, and practically all HCO⁺ ions have left the ion trap during this period. Accordingly, in the wavenumber range between approximately 2159.600 cm⁻¹ and 2159.607 cm⁻¹, which is resonant with the CO stretching vibration, the Gaussian curve 18 has an almost rectangular curve shape.

FIG. 4 shows a schematic representation of an effective potential of an ion trap of a device that can be used to perform a method for detecting a spectrum of an ion species, according to an embodiment. The device comprises the ion trap having the ion potential shown in FIG. 4. The ion trap is an ion trap comprising electrodes in a 22-pole configuration. Moreover, a ring electrode is arranged around the ion trap.

The upper part of FIG. 4 shows a section along the z-direction of the axis of the ion trap. The x-axis 28 of the diagram thus corresponds to the z-axis of the ion trap in the unit mm, the y-axis 30 of the diagram indicates the potential of the ion trap in meV.

The lower part of FIG. 4 shows a contour line diagram in the r-z plane of the ion trap. The x-axis 28 of the diagram thus corresponds to the z-axis of the ion trap in the unit mm, the y-axis 32 of the diagram thus corresponds to the radius of the ion trap in the unit mm. The ring electrode 34 is located 10 mm from a center of the ion trap (z=0) in the axial direction. In the lower diagram in FIG. 4, the effective potentials 36 are plotted in the r-z plane for a ring electrode 34a with a thickness of 0.5 mm (solid contour line 36a) and for a ring electrode 34b with a thickness of 0.15 mm (dashed contour line 36b) when 1 V is applied to the ring electrode 34 and 0 V is applied to an end electrode of the ion trap next to the ring electrode 34.

In the upper diagram, in addition to the potential 36a, 36b along the z-axis of the ion trap, for the two ring electrodes 34a, 34b of different thicknesses and when 1 V is applied to the ring electrode 34 and 0 V is applied to the end electrode of the ion trap next to the ring electrode 34, the ion potential 36c of the ring electrode 34b with a thickness of 0.15 mm is shown when 1 V is applied to the ring electrode 34b and −0.1 V is applied to the end electrode of the ion trap next to the ring electrode (dash-dotted line). The ring electrode 34 thus allows the setting of a low barrier in the meV energy range by use of an electrode potential of typically 1 V.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 spectrum
12 x-axis, wave number in cm⁻¹
14 measuring point
16 y-axis, normalized detector signal
18 Gaussian curve
20 maximum value of Gaussian curve
22 value known from literature for CO stretching vibration in HCO⁺
24 x-axis, time in seconds
26 exponential function curve
28 x-axis, axial axis of the ion trap in mm
30 y-axis, ion trap potential in meV
32 y-axis, radial axis of the ion trap in mm
34a ring electrode with 0.5 mm thickness
34b ring electrode with 0.15 mm thickness
36a contour line/ion trap potential for ring electrode 34a
36b contour line/ion trap potential for ring electrode 34b
36c contour line/ion trap potential for ring electrode 34b and voltage of end electrode of −0.1 V

1. Method for detecting a spectrum of an ion species, the method comprising the steps of:
a) capturing a subset of ions comprising the ion species in an ion trap;
b) thermalizing the ions captured in the ion trap by a buffer gas;
c) exciting the thermalized ions in the ion trap by electromagnetic radiation such that a kinetic energy of the ion species in the ion trap changes; and
d) detecting the ions leaving the ion trap and/or detecting the ions remaining in the ion trap via a detector.

2. Method according to claim 1, wherein in step c) the mass of the ion species does not change and/or no chemical reaction of the ion species with the buffer gas and/or a reaction partner takes place.

3. Method according to claim 1, wherein in step c) an energetic transition of the ion species is excited by the electromagnetic radiation.

4. Method according to claim 1, wherein step c) comprises converting internal energy of the ion species into kinetic energy of the ion species.

5. Method according to claim 1, wherein step c) comprises increasing internal energy of the ion species by excitation by via electromagnetic radiation and converting the increased internal energy of the ion species into kinetic energy of the ion species by collisions of the ion species with the buffer gas and/or a further buffer gas.

6. Method according to claim 1, wherein in step b) the ions captured in the ion trap are thermalized in such a way, and in step c) are excited by electromagnetic radiation in such a way, that after excitation by electromagnetic radiation an internal energy of the ion species is higher than a kinetic energy of the ion species after thermalization.

7. Method according to claim 1, wherein in step a) a subset of mass-selected ions comprising the ion species is captured in the ion trap.

8. Method according to claim 1, wherein in step a), for capturing the subset of ions, a storage potential of the ion trap is selected such that the ion species with changed kinetic energy leaves the ion trap.

9. Method according to claim 1, wherein in step d) a mass setting of the detector corresponds to the mass of the ion species.

10. Method according to claim 1, wherein the method comprises the steps of
e) removing all ions from the ion trap; and
f) repeating steps a) to e) with further subsets of the ions,
wherein during the repetition in step c) the electromagnetic radiation has each time a different frequency than before.

11. Method according to claim 10, wherein step d) comprises detecting the ions leaving the ion trap and/or detecting the ions remaining in the ion trap via the detector as a function of the excitation frequency.

12. Method of demixing a mixture of two or more ion species with equal mass-to-charge ratio, the method comprising the steps of:
a) capturing the ions comprising the mixture of two or more ion species with equal mass-to-charge ratio in an ion trap;
b) thermalizing the ions captured in the ion trap by a buffer gas; and
c) exciting exactly one ion species of the mixture of the thermalized ions in the ion trap by electromagnetic radiation such that a kinetic energy of this ion species in the ion trap changes,
wherein in step a), in order to capture the ions comprising the mixture, a storage potential of the ion trap is selected such that all particles of the ion species excited in step c) leave the ion trap after carrying out step c).

13. Method of determining a mixing ratio of a mixture of two or more ion species with equal mass-to-charge ratio, the method comprising the steps of:
a) capturing the ions comprising the mixture of two or more ion species with equal mass-to-charge ratio in an ion trap;
b) thermalizing the ions captured in the ion trap by a buffer gas;
c) exciting exactly one ion species of the mixture of the thermalized ions in the ion trap by electromagnetic radiation such that a kinetic energy of this ion species in the ion trap changes; and
d) detecting the ions leaving the ion trap and/or detecting the ions remaining in the ion trap by means of a detector,
wherein in step a), in order to capture the ions comprising the mixture, a storage potential of the ion trap is selected such that particles of the ion species excited in step c) leave the ion trap after step c) has been carried out.

14. Method according to claim 13, comprising the step of
e) determining whether a transition frequency belongs to a different ion species of the mixture than the ion species excited in step c) by irradiating electromagnetic radiation having a different frequency than that used for excitation in step c).

15. Device for performing a method according to claim 1, comprising an ion trap, wherein the ion trap comprises a plurality of electrodes for generating a radio frequency field, and wherein the electrodes are arranged in a multipole electrode configuration, wherein the device comprises a ring electrode arranged around the ion trap.

16. Device according to claim 15, comprising a further ion trap, wherein the first ion trap and the further ion trap are interconnected such that ions leaving the first ion trap are collected in the further ion trap.
